(19) United States
(12) Patent Application Publication
(10) Pub. No.: US 2015/0046556 A1
(43) Pub. Date: Feb. 12, 2015

(54) INFORMATION PROCESSING APPARATUS, METHOD OF CONTROLLING THE SAME, NON-TRANSITORY COMPUTER-READABLE STORAGE MEDIUM, AND INFORMATION PROCESSING SYSTEM

(71) Applicant: CANON KABUSHIKI KAISHA, Tokyo (JP)

(72) Inventor: Takuya Takenouchi, Kawasaki-shi (JP)

(21) Appl. No.: 14/445,575

(22) Filed: Jul. 29, 2014

(30) Foreign Application Priority Data
Aug. 12, 2013 (JP) 2013-167850

(51) Int. Cl. H04L 29/08

(52) U.S. Cl. CPC H04L 67/322
USPC 709/207

(57) ABSTRACT

An information processing apparatus acquires status information representing a status of a predetermined status item in an apparatus, and decides the acquired status as a subject for notification to be notified to a user upon meeting at least one of a condition that the status of the predetermined status item represented by the status information is different from a status represented by status information acquired before the acquisition and a condition that a priority of the predetermined status item is higher than a predetermined priority.

### BACKGROUND OF THE INVENTION

1. Field of the Invention

The present invention relates to an information processing apparatus, a method of controlling the same, a non-transitory computer-readable storage medium, and an information processing system and, more particularly, to an information processing apparatus that is connected to a network and controls a personal computer (to be referred to as a PC hereinafter), a mobile terminal, or the like connected to the network, and a peripheral device such as a multifunction printer connected to the network.

2. Description of the Related Art

Recently, Internet services that are called SNS (Social Networking Service) and allow anybody to freely register have become widespread. Especially, a real-time communication tool such as Twitter® allows a registered user to transmit a message, like a tweet, called a miniblog in real time. The real-time communication tool also has a function of registering another user, and can receive more tweet messages in real time. Such a real-time communication tool sometimes has a limitation on the information notification count so as to prevent an increase in the communication load and excessive stress on the user as a subject for notification.

On the other hand, there exists a technique of notifying a user who is accessing an information processing apparatus of the status information of a remote peripheral device in real time using a function such as instant message. Examples of the peripheral device are a TV, printer, copying machine, facsimile apparatus, scanner, digital camera, and multifunction peripheral including these functions. The information processing apparatus and the peripheral devices are connected to a network. The information processing apparatus notifies the user of status information received from each peripheral device. In this technique, if the information processing apparatus notifies the user of all pieces of received information, the user may be notified of unwanted information or untimely information as well. To prevent this, there is disclosed a technique of causing a user to set a numerical value serving as a threshold for status information that can be digitized and notifying the user of status information having a numerical value that has reached the threshold (U.S. Pat. No. 6,260,148).

In the technique of U.S. Pat. No. 6,260,148, however, if the numerical value of status information has continuously reached the threshold, the user is notified of the status information many times, and the notification count may exceed the limitation. As a result, the user may fail in receiving a notification of necessary status information.

### SUMMARY OF THE INVENTION

The present invention has been made in consideration of the above-described problems, and provides a technique of automatically determining status information that has high priority and needs to be notified to a user and performing notification.

According to one aspect of the present invention, there in provided an information processing apparatus comprising: an acquisition unit configured to acquire status information representing a status of a predetermined status item in an apparatus; and a decision unit configured to decide the acquired status as a subject for notification to be notified to a user upon meeting at least one of a condition that the status of the predetermined status item represented by the status information acquired by the acquisition unit is different from a status represented by status information acquired before the acquisition and a condition that a priority of the predetermined status item is higher than a predetermined priority.

Further features of the present invention will become apparent from the following description of exemplary embodiments (with reference to the attached drawings).

### BRIEF DESCRIPTION OF THE DRAWINGS

FIG. 1 is a block diagram showing the schematic arrangement of an MFP;

FIG. 2 is a block diagram showing the schematic arrangement of a PC;

FIG. 3 is a block diagram showing a network configuration;

FIG. 4 is a block diagram showing the software configuration of servers and a client according to the first embodiment;

FIGS. 5A and 5B are views showing examples of an XML format when transmitting status information;

FIG. 6 is a view showing an example of an error information table;

FIG. 7 is a view showing an example of a status information table;

FIG. 8 is a view showing an example of a priority information table;

FIGS. 9A and 9B are flowcharts showing the operations of the MFP and the servers according to the first embodiment;

FIG. 10 is a view showing a notification display screen for the user;

FIG. 11 is a block diagram showing the software configuration of servers and a client according to the second embodiment;

FIG. 12 is a view showing an example of a reception time management table;

FIG. 13 is a view showing an example of a reception interval information table;

FIGS. 14A and 14B are flowcharts showing the operations of an MFP and servers according to the second embodiment;

FIG. 15 is a view showing an example of an SNS account information table;

FIG. 16 is a flowchart showing the operation of the MFP at the time of SNS account registration; and

FIGS. 17A to 17C are views for explaining account setting processing for status information notification.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

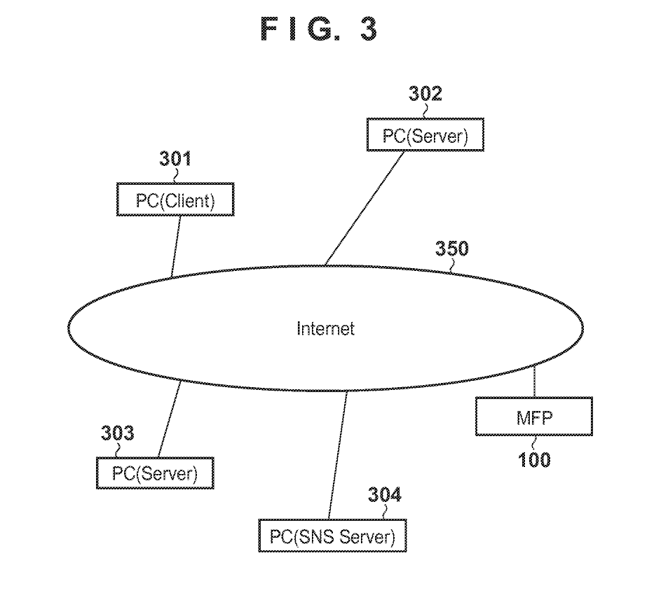

A multifunction peripheral (to be referred to as an MFP hereinafter) and PCs which are commonly used in the embodiments to be described below and a network configuration that connects them will be described first. General cloud printing that is performed using the MFP and the PCs will also be described. Note that FIG. 3 is a block diagram showing the network configuration that connects the MFP and the PCs.

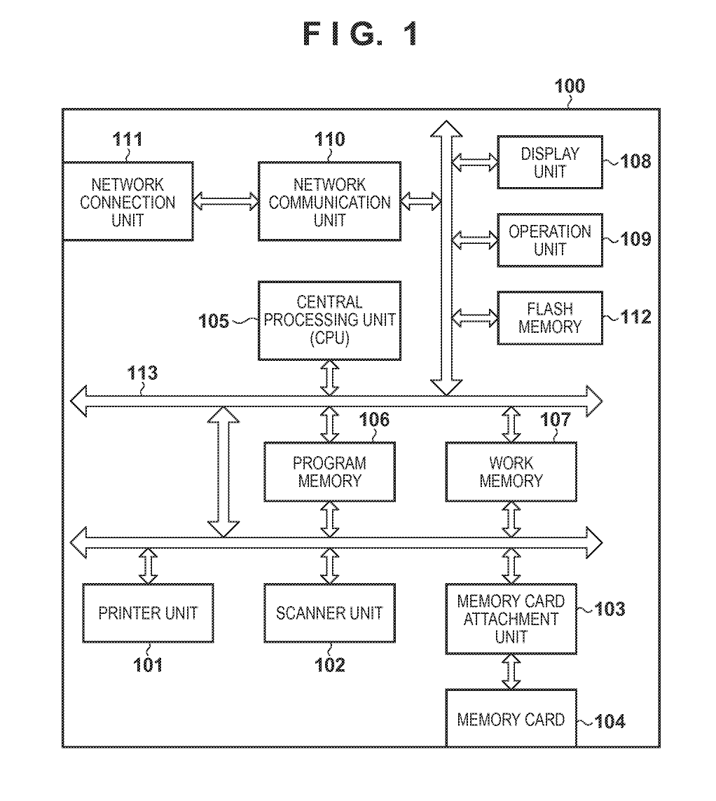

FIG. 1 is a block diagram showing the schematic arrangement of an MFP 100 according to this embodiment. The MFP 100 has a printer function, scanner function, and storage function, and can provide the service of each function or a service that combines the functions via a network. In the MFP 100, the printer function is implemented by a printer unit 101, the scanner function is implemented by a scanner unit 102, and the storage function is implemented by a memory card attachment unit 103 and a memory card 104.

The printer unit 101 prints externally received print data, image data stored in the memory card 104, or the like on a printing paper sheet by an inkjet method, an electrophotographic method, or the like. The scanner unit 102 optically reads an original set on a platen, converts it into digital data, converts the converted data into data of a designated file format, and transmits it to an external apparatus via the network. Note that the scanner unit 102 may store the data of the designated file format in a storage area (not shown) of the MFP instead of transmitting it to an external apparatus.

In a copy service that can be provided by combining the printer function and the scanner function, it is possible to transfer image data generated by reading an original by the scanner unit 102 to the printer unit 101 and cause the printer unit 101 to print the original data on a printing paper sheet. In a service that can be provided by the storage function, it is possible to cause an external apparatus connected via the network to read out and edit data stored in the memory card 104 and then store the updated data in the memory card. Note that these services are merely examples, and all services can be provided in accordance with the embodiment.

A CPU 105 controls units in the MFP. A program memory 106 is formed from a ROM or the like, and stores program codes and the like to be read out by the CPU 105. A work memory 107 is formed from a RAM or the like, and temporarily stores or buffers image data and the like when executing each service. A display unit 108 includes an LCD or the like, and performs display for the user. An operation unit 109 includes switches (to be described later), and is operated by the user.

A network communication unit 110 performs various kinds of communication control to connect the MFP 100 to the network. A network connection unit 111 connects the network communication unit 110 to a network medium. The network communication unit 110 supports at least one of wired LAN and wireless LAN. When the network communication unit 110 supports wired LAN, the network connection unit 111 serves as a connector configured to connect the cable of the wired LAN to the MFP 100. When the network communication unit 110 supports wireless LAN, the network connection unit 111 serves as an antenna. A memory 112 is formed from a nonvolatile flash or the like, and stores data received by the network communication unit 110. A signal line 113 connects the above-described units in the MFP. Note that the MFP 100 can perform HTTP communication or HTTPS communication with an information management server by further including a web browser (not shown) in the program memory 106 or the like.

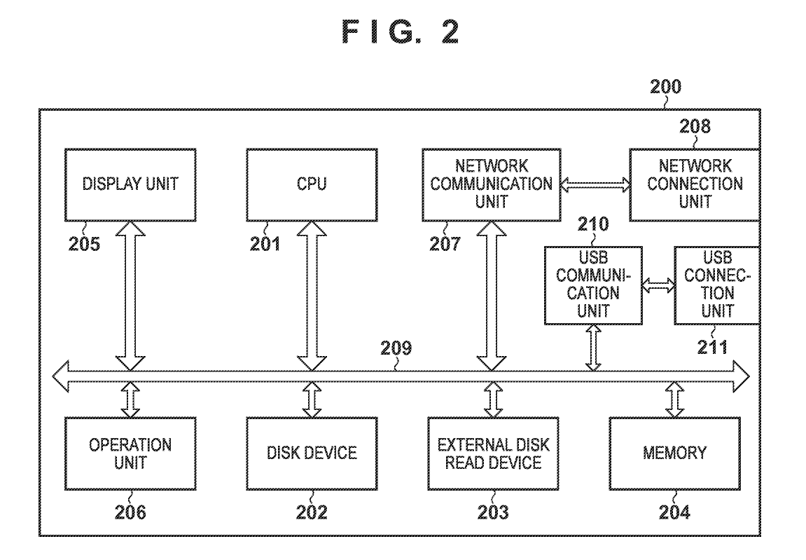

FIG. 2 is a block diagram showing the schematic arrangement of a PC 200 that is an example of an information processing apparatus according to this embodiment. In the PC 200, a CPU 201 controls units in the PC 200. The operating system (OS) and application programs to be read out by the CPU 201 are installed in a disk device 202. The disk device 202 stores various kinds of files and the like. An external disk read device 203 reads out contents of an external storage medium such as a CD-ROM. A memory 204 temporarily stores or buffers data. A display unit 205 includes an LCD and performs display for the user. An operation unit 206 includes a keyboard, a mouse, and the like, and is operated by the user.

A network communication unit 207 performs various kinds of communication control to connect the PC 200 to the network. A network connection unit 208 connects the network communication unit 207 to a network medium. As in the MFP 100, the network communication unit 207 and the network connection unit 208 support at least one of wired LAN and wireless LAN. As for a detailed form, they take necessary functions and forms in accordance with the supportable LAN, like the network communication unit 110 and the network connection unit 111 in the MFP 100. A signal line 209 connects the units. A USB communication unit 210 is connected to a USB connection unit 211 such as a connector, and communicates with various kinds of peripheral devices via the USB interface.

FIG. 3 is a block diagram showing the schematic arrangement of a network system including a client 301, servers 302 and 303, and an SNS server 304, which have the same arrangements as the MFP 100 shown in FIG. 1 and the PC 200 shown in FIG. 2. Referring to FIG. 3, the client 301 is a PC that has the same arrangement as the PC 200 and includes a client OS installed in it. Note that the client 301 may be not a PC but various devices such as a smartphone. The servers 302 and 303 are PCs that have the same arrangement as the PC 200 and include a server OS installed in them. The SNS server 304 is a PC that has the same arrangement as the PC 200 and provides services of, for example, posting and browsing a message. For example, the SNS server 304 provides an SNS application that is a web application such as Twitter® as a service.

The MFP 100, the server 302, the server 303, the client 301, and the SNS server 304 are connected via the Internet 350. The MFP 100 communicates with the server 302 via the Internet 350. The client 301 communicates with the server 303 via the Internet 350. Note that the connection method to the Internet 350 can be wired LAN or wireless LAN. The numbers of clients, servers, and MFPs connected to the Internet 350 are not limited to those of the example shown in FIG. 3. The number can be smaller than 2 or 3 or more.

General cloud printing will be explained here as the procedure of print processing according to this embodiment. Note that a web browser is installed in the client 301 as an application program, and a web application is installed in the server 302. First, via the web browser of the client 301, the user instructs the web application of the server 302 to print and designates the MFP 100 as the output destination printer. The server 302 converts an application document created by the web application into a general-purpose digital document represented by PDF (Portable Document Format). The server 302 issues a drawing command using the format-converted digital document and separately stored print setting information (not shown). A printer driver (not shown) installed in the server 302 converts the issued drawing command into a print command interpretable by the MFP 100, and transmits it to the MFP 100.

The MFP 100 performs a print operation in accordance with the print command received from the server 302, and obtains a desired printed product. The MFP 100 transmits status information to the server 302 at a predetermined interval. Status types represented by status information include print start, print completion, printer busy, out of paper, paper jam, paper cassette exchange, ink low, out of ink, and cover open. The MFP 100 temporarily stores codes corresponding to the statuses in the work memory 107, and transmits them to the server 302 via the network connection unit 111 together with the ID of the MFP 100.

Several embodiments implemented in the network system having the above-described arrangement will be described below. Note that a necessary condition to perform notification processing according to the embodiments (to be described later) is that the user completes account setting processing to be described next. That is, the user needs to create, on the client 301, an account (to be referred to as account 1 hereinafter) of his/her own necessary to use an SNS application in advance. Note that password setting also needs to be done in addition to account creation. Similarly, the user needs to create, on the MFP 100 or the client 301, an account (referred to as account 2 hereinafter) necessary to post the status information of the MFP 100 to the SNS server 304. In addition, the user needs to do setting on the MFP 100 so that the status information of the MFP 100 can be posted to the SNS server 304 using account 2. Furthermore, the user needs to make account 1 necessary to use the SNS application follow account 2 (register the user such that posts of another user are displayed on the screen of the local device) on the client 301.

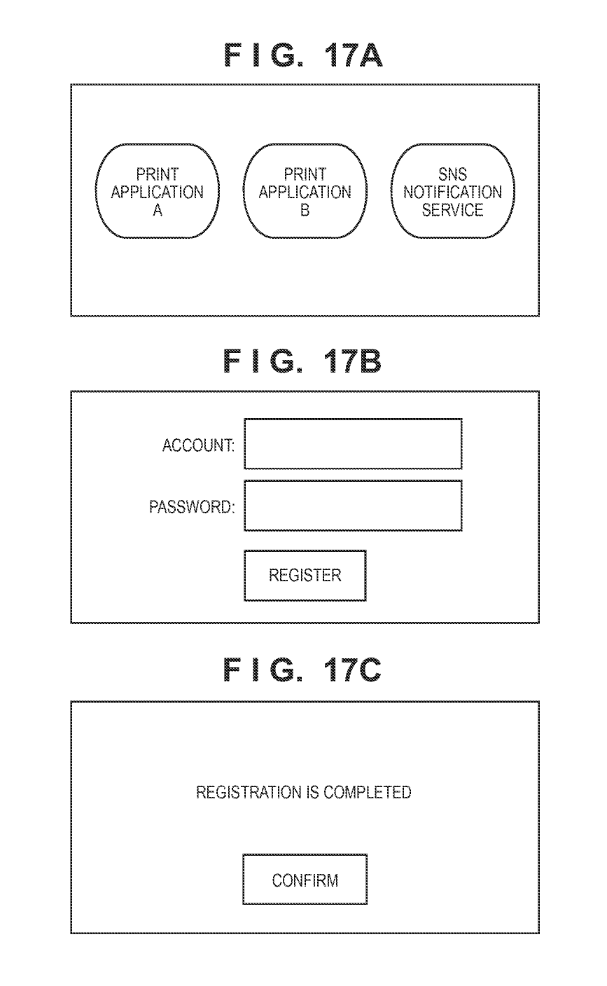

FIGS. 17A to 17C are views for explaining account setting processing for status information notification. FIG. 17A is a view showing a menu screen displayed on the display unit 108 of the MFP 100. When the user presses the button “SNS notification service”, the MFP 100 and the server 303 perform processing shown in the flowchart of FIG. 16. First, in step S1, the MFP 100 displays a registration screen as shown in FIG. 17B on the display unit 108. In step S2, the MFP 100 waits until the user inputs an SNS account (account 2) and a password and presses the registration button (NO in step S2). When the user inputs an SNS account and a password on the MFP 100 and presses the registration button, the MFP 100 transmits an MFP ID (unique ID assigned to each MFP) and the input SNS account and password to the server 303 in step S3. In step S4, the MFP 100 displays a registration completion screen as shown in FIG. 17C on the display unit 108. In step S5, the server 303 receives the MFP ID, SNS account, and password, and stores the received SNS account and password as the corresponding information of the received MFP ID. When the above-described processing ends, a setting to post the status information of the MFP 100 to the SNS server 304 using the SNS account is completed.

### First Embodiment

In the first embodiment, a server 302 notifies a client 301 of status information received from an MFP 100 via a server 303 and a plurality of extraction means in the server 302. More specifically, the server 302 first performs status change extraction processing of extracting, out of received status information, a status having a difference with respect to previously received status information. Next, the server 302 performs error extraction processing of extracting error information for the status extracted by the status change extraction processing. The server 302 also performs priority extraction processing of extracting status information having no status change but high notification priority. Status information selected based on these extraction processes is notified to the user. With these processes, it is possible to achieve suppression of the notification count without missing status information required by the user.

Note that in this embodiment, status information having a high notification priority means status information that needs to be notified to the user more quickly. An example is status information representing that the MFP 100 is in a state incapable of continuing printing, and a user operation is necessary for recovery from the state. Note that the priority can be predetermined or set by the user. Alternatively, a predetermined priority may be changed or adjusted by the user.

In this embodiment, the MFP 100 periodically notifies the server 302 of status information. However, the timing of status information notification is not limited to this. For example, status information notification may be done at an arbitrary timing before the start of printing or during printing. The status information notification may be done by polling of a query from the server 302 to the MFP 100. Note that the priority can be predetermined or set by the user. Alternatively, a predetermined priority may be changed or adjusted by the user.

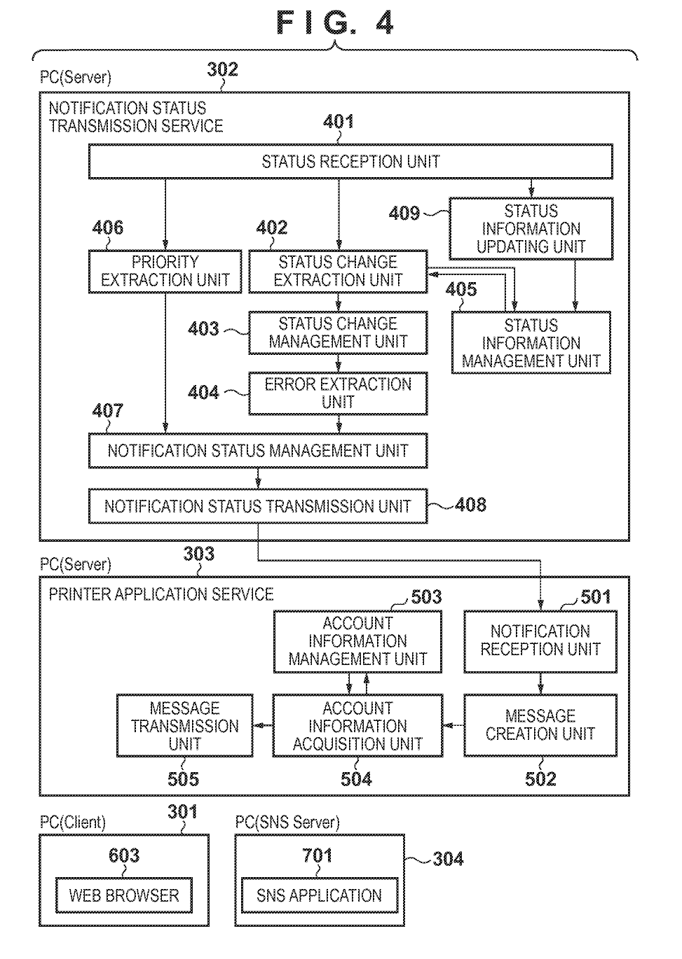

FIG. 4 is a block diagram showing a software configuration according to this embodiment. The server 302 provides a notification status transmission service in which status information is received from the MFP 100, status information that has changed from the previous one and includes an error or status information having a high priority is extracted, and the extracted status information is transmitted to the server 303. The server 303 provides a printer application service in which status information is received from the server 302, and a message is created based on the received status information and transmitted to an SNS server 304. The notification status transmission service by the server 302 will be described below.

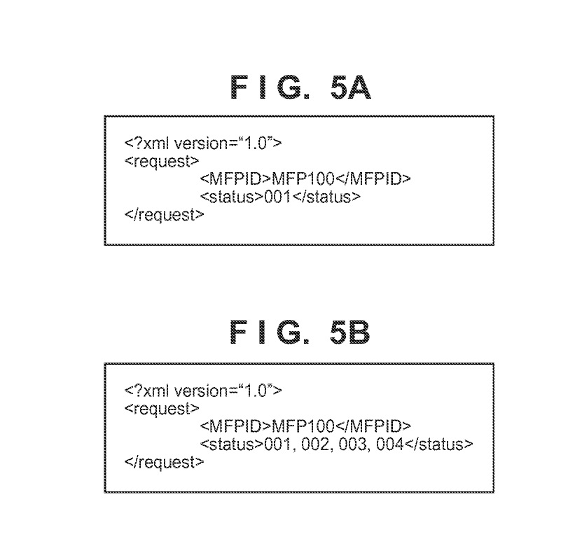

A status reception unit 401 of the server 302 receives status information of the MFP 100, which is transmitted from the MFP 100. The status information is described in, for example, an XML format as shown in FIG. 5A, and the status ID of each status item represented by the status information and including an error is transmitted. If there are a plurality of status items including an error, status IDs are separated by commas, as shown in FIG. 5B. The MFP ID of the MFP that has transmitted the status information is also added to the status information.

Note that if there are a plurality of status items in the MFP 100, the status information to be transmitted from the MFP 100 to the server 302 can be information representing the presence/absence of an error for all status items or information that notifies only items including an error. When an item including an error is described as status information, as in the latter case, for example, the MFP 100 determines the presence/absence of an error for each of the plurality of status items. The MFP 100 creates status information representing the items including an error and transmits it to the server 302.

A status change extraction unit 402 of the server 302 compares status information previously received from the MFP 100 and the status information currently received from the MFP 100. The status information previously received from the MFP 100 is stored in a status information table 1100 (FIG. 7) held by a status information management unit 405. The status change extraction unit 402 compares the previously received status information and the currently received status information, confirms and extracts a status that has changed, and stores it in a status change management unit 403.

FIG. 7 shows an example of the status information table 1100 held by the status information management unit 405. In the status information table 1100, an MFP ID 1101 is an ID assigned to each MFP. The value of the MFP ID 1101 is set so as not to repeat in the status information table 1100. The MFP ID 1101 serves as a main key when searching the status information table 1100 for status information of the MFP. An MFP status 1102 is a status ID corresponding to an error item including an error. When status information includes a plurality of statuses corresponding to errors, as shown in FIG. 5B, the MFP status 1102 includes a plurality of status IDs in correspondence with one MFP ID 1101. The status information table 1100 can also store other data managed and held on an MFP basis. Examples are MFP destination associated information and MFP version information. However, any other items may exist.

The status change extraction unit 402 can determine a change in a status by comparing the status information (FIG. 5) received from the MFP 100 with the previous status information (FIG. 7) stored in the status information management unit 405. More specifically, the status change extraction unit 402 specifies an MFP ID corresponding to the MFP ID included in the status information shown in FIG. 5A or 5B in the status information table 1100 shown in FIG. 7. The status change extraction unit 402 then compares a status ID corresponding to the specified MFP ID with the current status ID shown in FIG. 5A or 5B. For example, if the current status information includes a status ID that is not included in the previous status information, it can be determined that an error has occurred in the status item corresponding to the status ID after previous status information acquisition. On the other hand, if the current status information does not include a status ID that is included in the previous status information, it can be determined that an error was solved after previous status information acquisition.

The status change extraction unit 402 extracts a status ID that is included in the current status information and has a difference with respect to the previous status information, as described above, and notifies the status change management unit 403 of the status ID of the status item. That is, the status change management unit 403 is notified of a status ID that has changed from a no error state of previous time to error information. The status change extraction unit 402 also registers the currently received status information in the status information table 1100 held by the status information management unit 405 for comparison of next time.

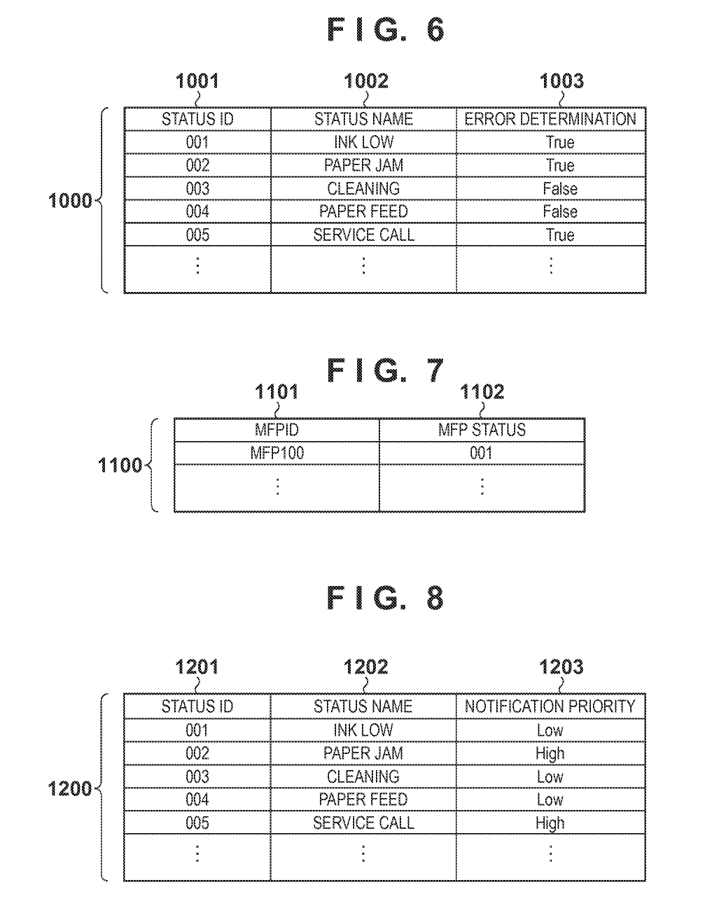

The status change management unit 403 of the server 302 stores and manages the status information (the MFP ID and the status ID of the status item that has changed from the previous time) extracted by the status change extraction unit 402. An error extraction unit 404 of the server 302 extracts an error from the status information stored in the status change management unit 403, and stores the extracted error in a notification status management unit 407. The error extraction unit 404 holds an error information table 1000 (FIG. 6) including a status ID, a status name representing the contents of status information, and a value representing whether the status has an error, and extracts an error using the table. The notification status management unit 407 of the server 302 stores and manages status information including a status that is decided as a subject for notification upon detecting an error.

FIG. 6 shows an example of the error information table 1000 held by the error extraction unit 404. In the error information table 1000, a status ID 1001 indicates the status ID of each status. The value of the status ID 1001 is set so as not to repeat in the error information table 1000. The status ID 1001 serves as a main key when searching the error information table 1000 for a status. A status name 1002 indicates the contents of a status. An error determination 1003 is a truth value representing whether a status has an error. More specifically, a status item that has changed from a no error state of previous time to an error state of current time and should be notified to the user as error information is set to True. For example, status “ink low” is set to True because the ink remaining amount, which was previously a predetermined amount or more, has currently changed to an amount smaller than the predetermined amount, and therefore has an influence on the operation of the MFP. On the other hand, status “cleaning” does not particularly affect the operation of the MFP at least this time and is therefore set to “False”.

For the status ID 1001 in the error information table, which matches the status ID included in the status information stored in the status change management unit 403, the error extraction unit 404 determines whether the error determination 1003 is True. If True, the error extraction unit 404 stores status information including the status ID as the status item of a subject for notification in the notification status management unit 407. When the status information stored in the status change management unit 403 includes a plurality of statuses, the error extraction unit 404 performs the determination for all statuses. The error extraction unit 404 then stores the status information including all statuses matching True in the notification status management unit 407.

With the above-described processing, a status item for which an error has occurred after the previous status information reception from the MFP 100 to the current status information reception can be decided as a subject for notification.

A priority extraction unit 406 of the server 302 extracts a status of a high priority from the plurality of status items of the MFP 100, and stores the status of the extracted status item in the notification status management unit 407. Note that to extract a status, the priority extraction unit 406 holds a corresponding information table 1200 (FIG. 8) representing a status ID, a status name corresponding to the status ID, and a notification priority.

FIG. 8 shows the priority information table 1200 held by the priority extraction unit 406. In the priority information table 1200, a status ID 1201 indicates the status ID of each status information. The value of the status ID 1201 is set so as not to repeat in the table 1200. The status ID 1201 serves as a main key when searching the priority information table 1200 for status information. A status name 1202 indicates the contents of a status. A notification priority 1203 represents the priority of notification of a status. For example, status “ink low” has no urgent influence on the operation of the MFP and is therefore set to “Low”. On the other hand, status “paper jam” has an urgent influence on the operation of the MFP and is therefore set to “High”. Note that the priority can be predetermined or set by the user. Alternatively, a predetermined priority may be changed or adjusted by the user. When the user sets, changes, or adjusts a priority, he/she can perform the operation using the operation unit on the server 301. Alternatively, a screen for priority setting may be displayed on the display unit of the MFP 100 or another terminal on the network, and the user may set, change, or adjust the priority on the screen and notify the server 301 of the priority after the operation. Note that the screen for priority setting may be provided by the server 301.

For the status ID 1201 in the table 1200, which matches the status ID of a status item including an error and included in the received status information, the priority extraction unit 406 determines whether the value of the notification priority 1203 is High. If High, the priority extraction unit 406 stores the status ID in the notification status management unit 407. When the received status information includes a plurality of statuses, the priority extraction unit 406 performs the determination for all statuses, and stores status information including all statuses set to High in the notification status management unit 407. With the processing of the priority extraction unit 406, a status item including an error and having a priority set to “High” can be decided as a subject for notification.

As described above, the notification status management unit 407 of the server 302 stores and manages statuses extracted by the error extraction unit 404 and the priority extraction unit 406 and set as subjects for notification. A notification status transmission unit 408 of the server 302 transmits the status information of the MFP 100 stored in the notification status management unit 407 to a notification reception unit 501 of the server 303. Note that when a status item having a high notification priority has changed to an error state from the previous time, both the error extraction unit 404 and the priority extraction unit 406 extract the status. In this case, since identical status IDs are extracted, the notification status management unit 407 manages them so as not to repeat. This can prevent the notification status transmission unit 408 from repetitively transmitting the same status ID and repetitively notifying the same error. On the other hand, a status information updating unit 409 of the server 302 updates the status information of the MFP by overwriting the status information of the MFP 100 received by the status reception unit 401 on the contents stored in the status information management unit 405. The status information previously received from the MFP 100 is thus updated to the currently received status information. Details of the notification status transmission service of the server 302 have been described above.

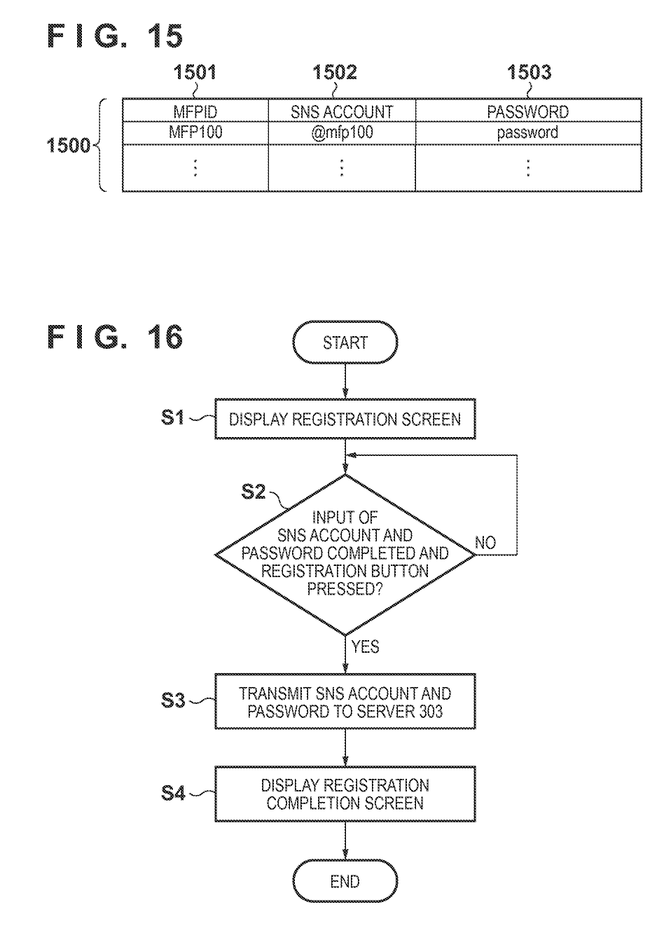

The printer application service of the server 303 will be described next. The notification reception unit 501 of the server 303 receives the status information of the MFP 100 from the server 302. A message creation unit 502 creates a notification message based on the status information received by the notification reception unit 501. An account information management unit 503 of the server 303 stores and manages SNS account information (account 2 and password) registered for each MFP using a table 1500 (FIG. 15). An account information acquisition unit 504 acquires SNS account information registered in advance on the MFP 100 from the account information management unit 503. A message transmission unit 505 of the server 303 transmits the SNS account and password acquired from the account information management unit 503 to the SNS server 304 via the Internet.

FIG. 15 shows an example of the SNS account information table 1500 held by the account information management unit 503. In the SNS account information table 1500, an MFP ID 1501 indicates an ID assigned to each MFP. The value of the MFP ID 1501 is set so as not to repeat in the table 1500. The MFP ID 1501 serves as a main key when searching the SNS account information table 1500 for the SNS account information of an MFP. An SNS account 1502 is an SNS account name registered for each MFP. A password 1503 is the password of an SNS account registered for each MFP. Details of the printer application service of the server 303 have been described above.

The SNS server 304 receives a notification message, an SNS account, and a password from the server 303. An SNS application 701 of the SNS server 304 provides, as a service, an SNS application that is a web application such as Twitter®. The user recognizes the notification message on the client 301 via a web browser 603.

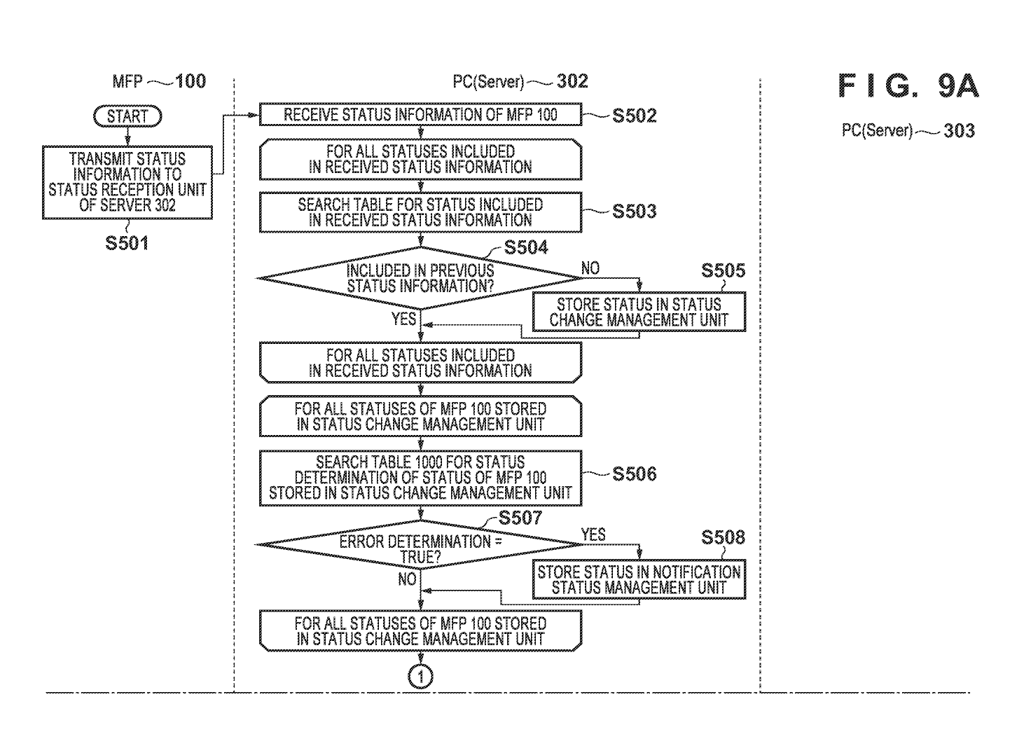

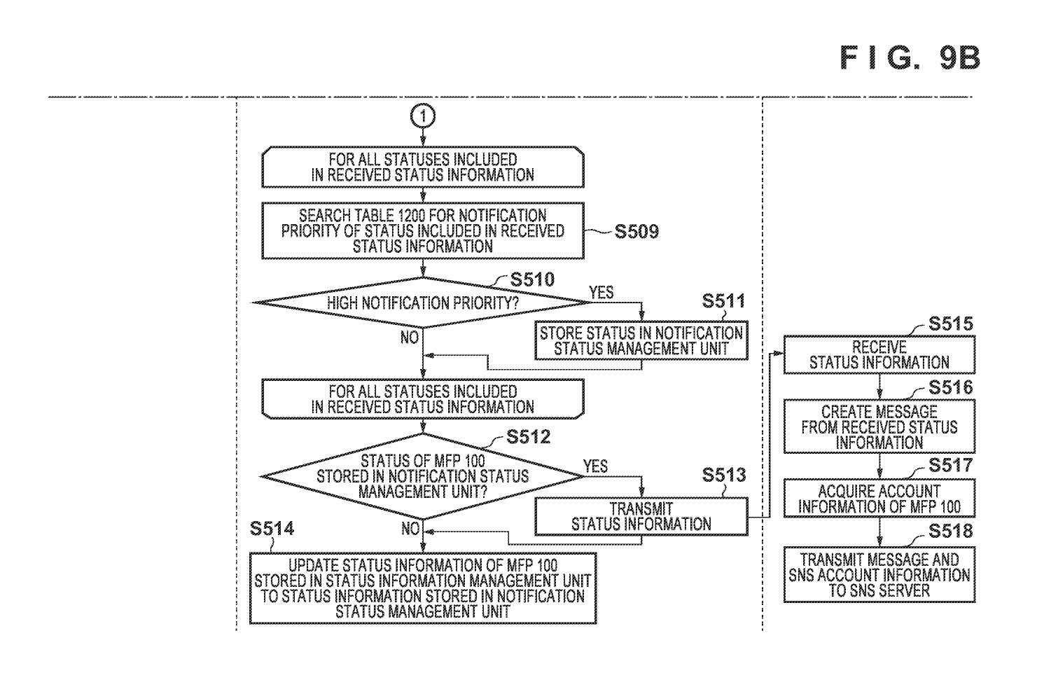

An operation procedure according to this embodiment will be described next with reference to FIGS. 9A and 9B. FIGS. 9A and 9B are flowcharts showing an operation of notifying the SNS server 304 of status information via the servers 302 and 303 concerning a status that has occurred in the MFP 100 according to this embodiment. An operation of causing the MFP 100 to transmit status information to the server 302 and causing the server 302 to receive it will be described first with reference to steps S501 and S502 of FIG. 9A. Note that programs corresponding to the processes of the MFP 100 and the servers in the flowcharts shown in FIGS. 9A, 9B 14A, 14B and 16 (to be described later) are stored in the ROMs of the MFP 100 and the servers. The CPUs of the MFP 100 and the servers execute the programs on memories, thereby implementing the processes shown in FIGS. 9A, 9B 14A, 14B and 16.

In step S501, the MFP 100 transmits status information to the status reception unit 401 of the server 302. The status information is described in, for example, an XML format as shown in FIG. 5A or 5B. In step S502, the status reception unit 401 of the server 302 receives the status information (MFP ID and status ID) from the MFP 100.

An operation of extracting, from statuses included in the status information currently received from the MFP 100, a status that is not included in the previously received status information will be described next with reference to steps S503 to S505 of FIG. 9A. First, in step S503, the status change extraction unit 402 determines, using the status information table 1100, whether a status included in the currently received status information is included in the previously received status information. Note that when the currently received status information of the MFP 100 includes a plurality of statuses, the status change extraction unit 402 performs the determination for all statuses. Upon determining in step S504 that the status as the subject for determination is not included in the previously received status information, the status change extraction unit 402 stores the status (status ID) in the status change management unit 403 as status information together with the MFP ID in step S505. Upon determining in step S504 that the status as the subject for determination is included in the previously received status information, the status change extraction unit 402 does not particularly perform processing.

An operation of extracting an error from the status information stored in the status change management unit 403 will be described next with reference to steps S506 to S508 of FIG. 9A. First, in step S506, the error extraction unit 404 confirms the error determination 1003 (“True” or “False”) for the status ID 1001 in the table 1000, which matches the status ID included in the status information stored in the status change management unit 403. Note that when the status information stored in the status change management unit 403 includes a plurality of statuses, the error extraction unit 404 performs the confirmation for all statuses. Upon determining in step S507 that the error determination is True, the error extraction unit 404 stores the status (status ID) in the notification status management unit 407 as status information together with the MFP ID in step S508. Upon determining in step S507 that the error determination is False, the error extraction unit 404 does not particularly perform processing.

An operation of extracting a status having a high priority from the status information received from the MFP 100 will be described next with reference to steps S509 to S511 of FIG. 9B. First, in step S509, the priority extraction unit 406 confirms the notification priority 1203 (“High” or “Low”) for the status ID 1201 in the table 1200, which matches the status included in the currently received status information. Note that when the currently received status information of the MFP 100 includes a plurality of statuses, the confirmation is performed for all statuses. Upon determining in step S510 that the priority is High, the priority extraction unit 406 stores the status (status ID) in the notification status management unit 407 as status information together with the MFP ID in step S511. Upon determining in step S510 that the priority is Low, or when the status ID 1201 of the table 1200, which matches the status included in the received status information, is not found, the priority extraction unit 406 does not particularly perform processing.

An operation of transmitting status information stored in the notification status management unit 407 to the server 303 and updating the status information stored in the status information management unit 405 will be described next with reference to steps S512 to S514 of FIG. 9B. In step S512, the notification status transmission unit 408 confirms whether one or more pieces of status information are stored in the notification status management unit 407. Upon confirming in step S512 that one or more pieces of status information are stored in the notification status management unit 407, the notification status transmission unit 408 transmits the status information stored in the notification status management unit 407 to the notification reception unit 501 of the server 303 in step S513. The MFP ID of the MFP 100 is added to the status information to be transmitted. Note that if there are identical statuses, the notification status transmission unit 408 transmits one of them. In step S514, the status information updating unit 409 updates the MFP status 1102 that corresponds to the MFP ID 1101 of the table 1100 and matches the MFP ID of the MFP 100 to the status included in the status information of the MFP 100 received by the status reception unit 401. On the other hand, if no status information is stored in the notification status management unit 407 at all in step S513, the process advances to step S514.

An operation of causing the server 303 to receive the status information from the server 302, create a message from the received status information, and transmit the created message to the SNS server 304 will be described next with reference to steps S515 to S518 of FIG. 9B. In step S515, the notification reception unit 501 of the server 303 receives the status information of the MFP 100 transmitted from the notification status transmission unit 408 of the server 302. The MFP ID of the MFP 100 is added to the received status information. In step S516, the message creation unit 502 creates a message to be notified to the user from the received status information. In step S517, the account information acquisition unit 504 acquires the SNS account 1502 and the password 1503 corresponding to the MFP ID 1501 in the table of the account information management unit 503, which matches the MFP ID of the MFP 100. In step S518, the message transmission unit 505 transmits the created message and the acquired SNS account and password to the SNS server 304.

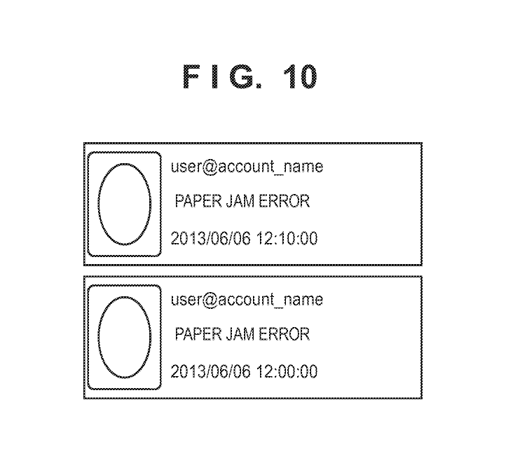

The SNS server 304 receives the message and the SNS account and password transmitted from the server 303. The SNS server 304 sets the received message as a post of the received SNS account, and displays a message as shown in FIG. 10 on the time line of the user who follows the account. FIG. 10 shows an example of a notification display screen for the user according to this embodiment. On the time line, messages posted by other accounts followed by the user are arranged and displayed in the chronological order. Note that the user needs to do login in advance using his/her account (account 1) of the SNS application on the web browser of the client 301.

As described above, according to this embodiment, when at least one of two conditions: 1. a status item that has changed from the previous status to an error state, and 2. a status item including an error and having a high priority, is met, the user is notified of the error of the status item. For this purpose, the server 302 extracts status information of high priority which should be notified to the user. An item which includes an error but has not changed from the previous time (continuous error state) is not notified to the user. It is therefore possible to perform effective status information notification while suppressing the notification count. Note that in this embodiment, all of status change extraction processing, error extraction processing, and priority extraction processing are performed as the status information extraction processing of the server 302, as described above. However, the same effects as described above can be obtained even when some of the processes are combined or the processes are executed in a different order. For example, even when only status change extraction processing and error extraction processing are set, the same effects as described above can be obtained depending on details or diversity of status information obtained from the MFP. Alternatively, the order of status change extraction processing and error extraction processing may be reversed.

### Second Embodiment

In the above-described first embodiment, after status change extraction processing, error extraction processing, and priority extraction processing are performed for status information received from the MFP 100, notification to the user is performed. In the second embodiment, status change extraction processing of extracting the status difference from the previous time and error extraction processing of extracting error information are first performed for status information received from an MFP 100. These processes are the same as those described in the first embodiment. In the second embodiment, notification interval extraction processing of extracting a status received after the elapse of a predetermined time from the previous reception time is performed. After these processes are performed, the user is notified of the status information. Note that in this embodiment, the MFP 100 periodically performs status notification to a server 302. However, the timing of status notification is not limited to this, as described in the first embodiment.

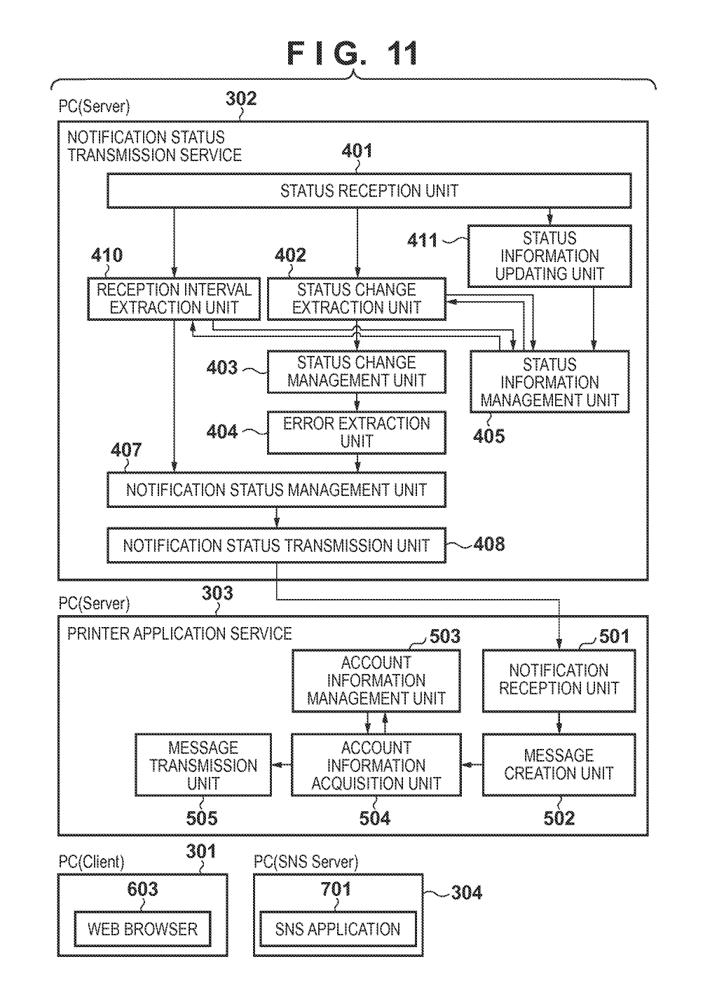

FIG. 11 is a block diagram showing a software configuration according to this embodiment. The server 302 provides a notification status transmission service in which status information is received from the MFP 100, status information different from previously received status information or status information after the elapse of a predetermined time from the previous reception time is extracted, and the extracted status information is transmitted to a server 303. Note that the operations of the server 303 and a client 301 are the same as in the first embodiment, and a description thereof will be omitted.

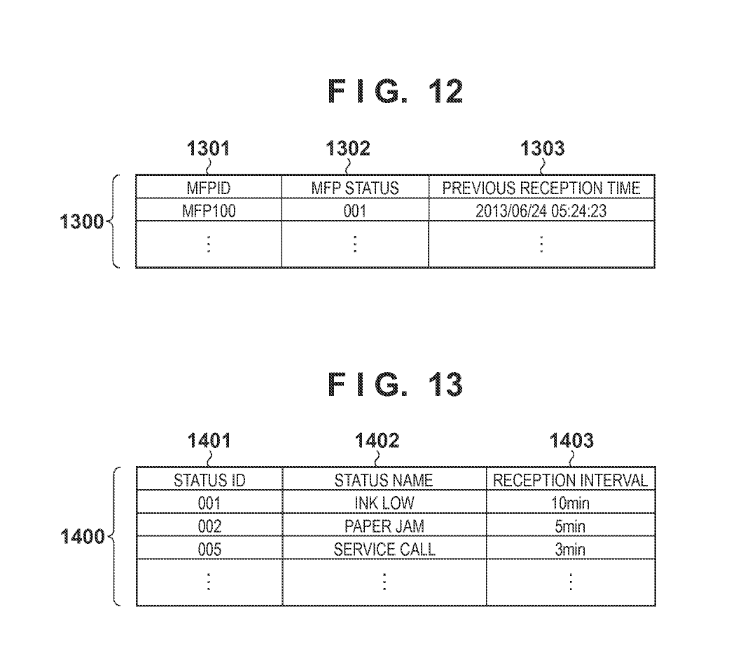

A status information management unit 405 of the server 302 stores and manages previously received status information and the reception time for each MFP using a reception time management table 1300. FIG. 12 shows an example of the reception time management table 1300 held by the status information management unit 405. In the reception time management table 1300, an MFP ID 1301 and an MFP status 1302 are the same as the MFP ID 1101 and the MFP status 1102 in FIG. 7, respectively, and a description thereof will be omitted. A previous reception time 1303 is the latest date/time of status reception. The previous reception time 1303 need not always be an accurate date/time and may be a time or the like measured from a predetermined time. Note that the reception time management table 1300 can also store other data managed and held on an MFP basis. Examples are MFP destination associated information and MFP version information. However, any other items may exist.

A reception interval extraction unit 410 of the server 302 compares the previous status information reception time and the current status information reception time (current time), which are managed by the status information management unit 405, for each status included in the status information using a reception interval information table 1400. The reception interval extraction unit 410 searches for a status for which the time difference between the two times is a predetermined time or more, and stores status information including a status for which the time difference is the predetermined time or more in a notification status management unit 407 as a subject for notification. The rest of the arrangement is the same as in the first embodiment, and a description thereof will be omitted.

FIG. 13 shows an example of the reception interval information table 1400 held by the reception interval extraction unit 410. In the reception interval information table 1400, a status ID 1401 and a status name 1402 are the same as the status ID 1001 and the status name 1002 in FIG. 6, respectively, and a description thereof will be omitted. A default interval 1403 is a time interval predetermined based on the priority of notification to the user. Note that FIG. 13 shows an example in which the default interval for the reception interval of each status is set. However, not the reception interval but a print timing at the start of printing, during printing, at the completion of printing, or the like is also usable to obtain the same effect.

The reception interval extraction unit 410 calculates the elapsed time from previous reception for the status as the subject for determination on the current time and the previous reception time 1303 in the table 1300 stored in the status information management unit 405. The reception interval extraction unit 410 compares the calculated elapsed time with the value of the default interval 1403 of the table 1400 corresponding to the status as the subject for determination, and determines whether the elapsed time is more than the default interval 1403. Upon determining that the elapsed time is more than the default interval 1403, status information including the status as the subject for determination is stored in the notification status management unit 407. When a plurality of statuses are stored in the status information management unit 405, the reception interval extraction unit 410 performs the determination for all statuses, and stores all statuses determined to match in the notification status management unit 407.

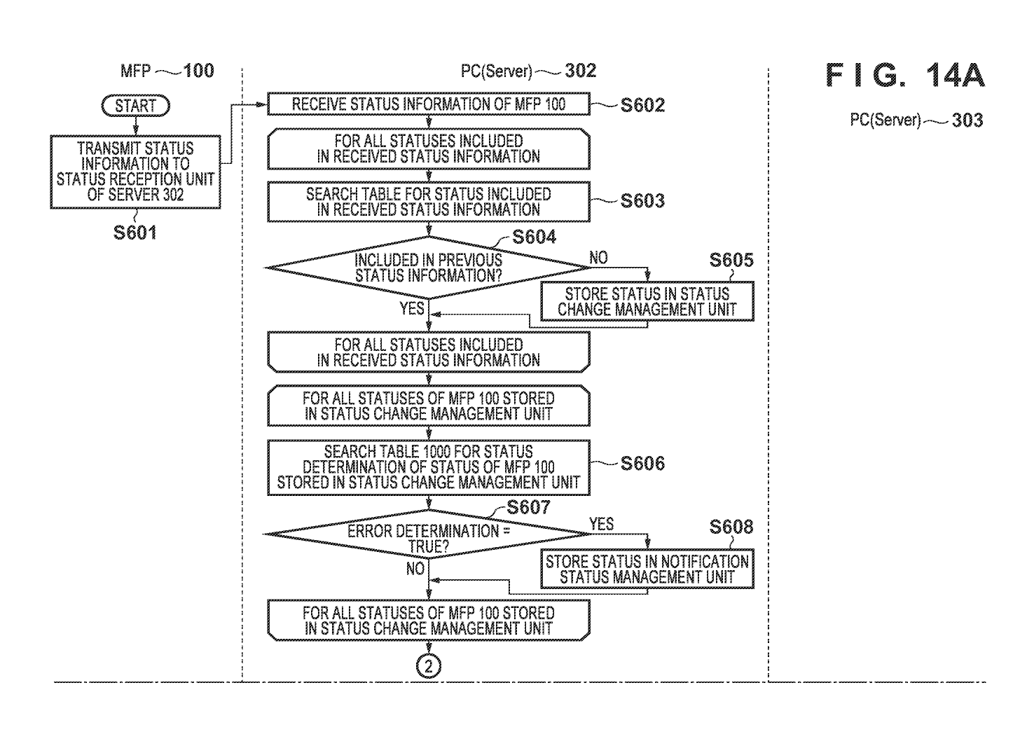

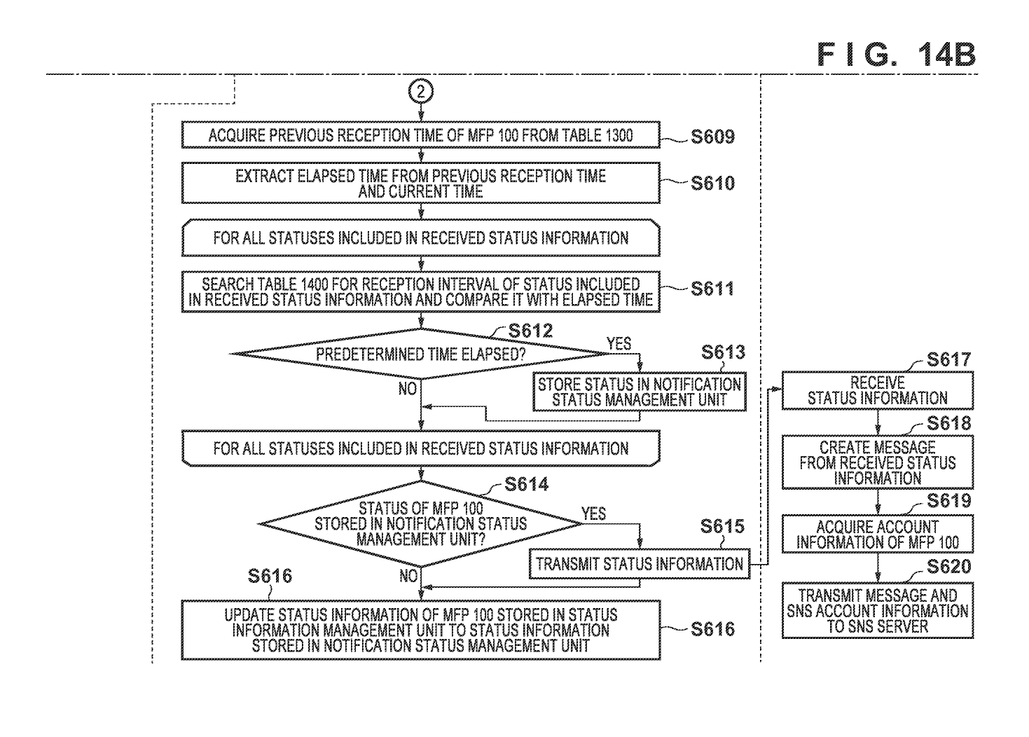

FIGS. 14A and 14B are flowcharts showing processing of notifying an SNS server 304 of status information via the servers 302 and 303 concerning a status that has occurred in the MFP 100 according to the second embodiment. Steps S601 and S602 configured to cause the MFP 100 to transmit status information to the server 302 and cause the server 302 to receives it are the same as steps S501 and S502 of the first embodiment, and a description thereof will be omitted. Steps S603 to S605 configured to extract, from the received status information, a status that is not included in the previous status information are the same as steps S503 to S505 of the first embodiment, and a description thereof will be omitted. Steps S606 to S608 configured to extract an error from the status information stored in the status change management unit 403 are the same as steps S506 to S508 of the first embodiment, and a description thereof will be omitted.

A configuration for extracting, from the received status information, a status for which a predetermined time has elapsed from the previous reception time will be described next with reference to steps S609 to S613 of FIG. 14B. In step S609, the reception interval extraction unit 410 acquires the previous reception time 1303 corresponding to the MFP ID 1301 of the table 1300, which matches the MFP ID of the MFP 100. In step S610, the reception interval extraction unit 410 calculates the elapsed time from the previous reception based on the difference between the current time and the acquired previous reception time 1303. In step S611, the reception interval extraction unit 410 compares the calculated elapsed time with the default interval 1403 corresponding to the status ID 1401 of the table 1400, which matches the status included in the received status information. Upon determining in step S612 that the elapsed time is more than the default interval in comparison, the reception interval extraction unit 410 stores the status information including the status as the subject for determination in the notification status management unit 407 in step S613. Upon determining in step S612 that the elapsed time is not more than the default interval in comparison, the reception interval extraction unit 410 does not particularly perform processing. Note that when the received status information of the MFP 100 includes a plurality of statuses, the processing is performed for all statuses.

A configuration for transmitting the status information stored in the notification status management unit 407 to the server 303 and updating the status information stored in the status information management unit 405 will be described next with reference to steps S614 to S616 of FIG. 14B. Steps S614 and S615 are the same as steps S512 and S513 of the first embodiment, and a description thereof will be omitted. In step S616, a status information updating unit 411 updates the MFP status 1302 and the previous reception time 1303 corresponding to the MFP ID 1301 in the table 1300, which matches the MFP ID of the MFP 100, to the status information of the MFP 100 received by the status reception unit 401 and the current time, respectively. Steps S617 to S620 configured to cause the server 303 to receive the status information from the server 302, create a message from the received status information, and transmit the created message to the SNS server are the same as steps S515 and S518 of the first embodiment, and a description thereof will be omitted.

As described above, according to this embodiment, status information to be notified to the user is extracted by the server 302, thereby performing effective status information notification while suppressing the notification count. Note that in this embodiment, all of status change extraction processing, error extraction processing, and reception interval extraction processing are performed as the status information extraction processing of the server 302, as described above. However, the same effects as described above can be obtained even when some of the processes are combined. Alternatively, some of the processes including priority extraction processing described in the first embodiment may be combined.

In the above-described embodiments, the servers 302 and 303 have been described separately. However, they may be included in a single server configuration. The configuration of the server 302 may include a plurality of server configurations. The MFP 100 and the servers 302 and 303 have been described separately. However, they may be included in a single server configuration.

According to the above embodiments, it is possible to provide a status notification system capable of reducing restrictions on usability by controlling not to suffer the influence of the notification count limit in a real-time communication tool.

Note that in the above embodiments, a status item that has changed to an error state from the previous time is notified. However, the present invention is not limited to this. A status item previously in an error state but not currently, that is, a status item whose error has been released may be notified. In this case, when the server 302 transmits the status ID of the subject for notification to the server 303, information representing whether the status item corresponding to the status ID is a subject for error notification or a subject for error release notification is transmitted. The server 303 can perform error notification or error release notification in accordance with the information.

In the above embodiments, even when an error has occurred, error notification is not performed for a status item having a priority “Low” and including an error from the previous time. However, the present invention is not limited to this. Even when the priority is “Low”, and an error is included from the previous time, notification to the user may be done unless the notification count has reached a predetermined upper limit. However, in this case as well, error notification of an item including an error state and having a priority “High” is preferentially performed. This makes it possible to reliably perform error notification of high priority and error notification of low priority as well while suppressing the notification count to the above-described upper limit or less.

In the above embodiments, the status of an MFP has been exemplified. However, the present invention is not limited to this, and the statuses of various kinds of devices such as a PC, smartphone, and camera are also usable.

In the above embodiments, currently acquired status information is compared with a previous one. However, the present invention is not limited to this. Comparison with status information corresponding to a previous notification may be performed. For example, when status information is previously received, and new status information is acquired before performing a notification based on the previously received status information, Not the previously acquired status information but status information corresponding to the previous notification may be referred to.

In the above embodiments, to determine whether the priority of a status item is higher than a predetermined priority, priorities “High” and “Low” are set. When the priority is “High”, it is higher than the predetermined priority. However, the present invention is not limited to this. A plurality of priorities may be provided. Alternatively, a numerical value representing a priority may be set, and it may be determined whether the numeral value is larger than a predetermined value.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-167850, filed Aug. 12, 2013 which is hereby incorporated by reference herein in its entirety.

What is claimed is:

1. An information processing apparatus comprising:
an acquisition unit configured to acquire status information representing a status of a predetermined status item in an apparatus; and
a decision unit configured to decide the acquired status as a subject for notification to be notified to a user upon meeting at least one of a condition that the status of the predetermined status item represented by the status information acquired by said acquisition unit is different from a status represented by status information acquired before the acquisition and a condition that a priority of the predetermined status item is higher than a predetermined priority.

2. The apparatus according to claim 1, wherein said decision unit decides the status as the subject for notification to the user upon further meeting a condition that the status acquired by said acquisition unit corresponds to an error.

3. The apparatus according to claim 1, further comprising a management unit configured to store the status information acquired by said acquisition unit,
wherein said decision unit compares the status represented by the status information acquired by said acquisition unit with contents stored in said management unit, thereby confirming the status different from the status represented by status information acquired by said acquisition unit.

4. The apparatus according to claim 1, wherein when the status information acquired by said acquisition unit represents statuses of a plurality of status items, said decision unit decides a status item that meets the condition out of the plurality of status items, and decides a status corresponding to the decided status item as the subject for notification.

5. The apparatus according to claim 4, wherein said decision unit holds priority information representing correspondence between the plurality of status items in the apparatus and priorities of the notification, and performs the decision using the priority information.

6. The apparatus according to claim 1, wherein said decision unit performs the decision further based on a time difference between a time of acquisition by said acquisition unit and a time of previous acquisition.

7. The apparatus according to claim 1, further comprising a transmission unit configured to, when the status of the predetermined status item is decided as the subject for notification by said decision unit, transmit information representing the decision to an external apparatus,
wherein the external apparatus notifies the user of the status in accordance with transmission of the information by said transmission unit.

8. The apparatus according to claim 1, wherein said acquisition unit acquires the status and an ID of the apparatus from the apparatus, and
said decision unit specifies the status of the apparatus acquired before the acquisition based on the acquired ID and an ID acquired before the acquisition, thereby determining a change in the status of the apparatus.

9. The apparatus according to claim 8, wherein the status information includes the status and the ID of the apparatus.

10. An information processing method comprising:
an acquisition step of acquiring status information representing a status of a predetermined status item in an apparatus; and
a decision step of deciding the acquired status as a subject for notification to be notified to a user upon meeting at least one of a condition that the status of the predetermined status item represented by the status information acquired in the acquisition step is different from a status represented by status information acquired before the acquisition and a condition that a priority of the predetermined status item is higher than a predetermined priority.

11. A system including a first information processing apparatus and a second information processing apparatus,
the first information processing apparatus comprising:
an acquisition unit configured to acquire status information representing a status of a predetermined status item in an apparatus; and
a decision unit configured to decide the acquired status as a subject for notification to be notified to a user upon meeting at least one of a condition that the status of the predetermined status item represented by the status information acquired by said acquisition unit is different from a status represented by status information acquired before the acquisition and a condition that a priority of the predetermined status item is higher than a predetermined priority, and
the second information processing apparatus comprising:
a reception unit configured to receive a notification based on the status when the decision has been done by said decision unit.

12. A non-transitory computer-readable storage medium storing a computer program for controlling a computer to execute respective steps of claim 10.
